(19) United States
(12) Patent Application Publication
(10) Pub. No.: US 2026/0028020 A1
(43) Pub. Date: Jan. 29, 2026

(54) VEHICLE TRAVEL CONTROL DEVICE

(71) Applicant: TOYOTA JIDOSHA KABUSHIKI KAISHA, Toyota-shi (JP)

(72) Inventor: Yuichi TAKEHIRA, Toyota-shi (JP)

(73) Assignee: TOYOTA JIDOSHA KABUSHIKI KAISHA, Toyota-shi (JP)

(21) Appl. No.: 19/078,331

(22) Filed: Mar. 13, 2025

(30) Foreign Application Priority Data
Jul. 26, 2024 (JP) 2024-120969

(51) Int. Cl. B60W 30/09; B60W 30/095

(52) U.S. Cl. CPC B60W 30/09; B60W 30/0956; B60W 2420/403; B60W 2420/408; B60W 2552/15; B60W 2552/53; B60W 2554/402; B60W 2554/60; B60W 2554/802; B60W 2556/35

(57) ABSTRACT

This vehicle travel control device includes a camera sensor and a radar sensor capable of measuring a distance to a target as first and second distances, respectively, and a driving assistance ECU for executing travel control. The driving assistance ECU stores a relation between a plurality of first distances determined in advance and a correction coefficient for determining a fusion distance based on the first distance and the second distance based on the first distance. When determining that a specific structure exists in a predetermined area, the driving assistance ECU obtains a correction coefficient from the relationship based on the first distance for the specific structure, and performs travel control for the specific structure based on the fusion distance obtained as a product of the correction coefficient and the first distance.

### CROSS-REFERENCE TO RELATED APPLICATION

This application claims priority to Japanese Patent Application No. 2024-120969 filed on Jul. 26, 2024. The disclosure of the above-identified application, including the specification, drawings, and claims, is incorporated by reference herein in its entirety.

### BACKGROUND

### 1. Technical Field

The present disclosure relates to a travel control device for a vehicle such as an automobile.

### 2. Description of Related Art

As one of travel control devices, there is known a travel control device that executes travel control for reducing the possibility of a collision between a host vehicle and an obstacle when it is determined that an obstacle such as a pedestrian is present ahead of the host vehicle. For example, Japanese Unexamined Patent Application Publication No. 2017-182768 (JP 2017-182768 A) describes a travel control device that automatically decelerates a vehicle by braking as travel control for reducing the possibility of a collision between the host vehicle and a pedestrian.

### SUMMARY

A structure having a low height such as a curbstone or a step may be present between the host vehicle and the pedestrian, depending on the traveling situation of the host vehicle, such as when the host vehicle travels obliquely with respect to the road. When the host vehicle passes over a structure such as a curbstone or a step, the behavior of the host vehicle becomes unstable, and therefore the travel control for reducing the possibility of a collision between the host vehicle and the pedestrian may not be properly performed.

In the travel control for reducing the possibility of a collision, in general, a fusion process based on the detection results of a camera sensor and a radar sensor is performed, whereby an obstacle ahead of the host vehicle and the distance to the obstacle are detected with high accuracy. However, when the object to be detected is a structure having a low height, it is difficult for the radar sensor to detect the object, the fusion process becomes complicated, and therefore the distance to the object cannot be accurately detected.

It is conceivable to use a LiDAR in order to accurately detect the distance to a structure having a lower height. Since the LiDAR is more expensive than the radar sensor, however, the travel control device inevitably becomes expensive.

The present disclosure provides a travel control device that executes travel control for reducing the possibility of a collision between the host vehicle and an obstacle. The travel control device of the present disclosure can execute the travel control by accurately detecting the distance to a structure having a low height without requiring an expensive sensor such as a LiDAR.

According to an aspect of the present disclosure, there is provided a vehicle travel control device (100) including: a camera sensor (12) and a radar sensor (14) that measure a distance to a target as a first distance (Lc) and a second distance (Ll), respectively; and a control unit (driving assistance ECU 10) that executes travel control for reducing a possibility of a collision between a host vehicle (102) and an obstacle when it is determined that the obstacle is present in a predetermined area in a traveling direction of the host vehicle based on detection results of the camera sensor and the radar sensor.

The control unit (driving assistance ECU 10) stores a relationship between the first distance and a correction coefficient (Ki) determined in advance for a plurality of first distances (Lci), the correction coefficient being a coefficient for the first distance for determining, based on the first distance, a fusion distance (Lfi) based on the first distance and the second distance.

When it is determined that a specific structure (126) is present in the predetermined area (S60), a distance to the specific structure being measurable by the camera sensor (12) but it being difficult for the radar sensor (14) to measure an accurate distance to the specific structure, the control unit (driving assistance ECU 10) determines a correction coefficient (Ki) from the relationship based on the first distance (Lci) for the specific structure (S90), determines a fusion distance (Lfi) to the specific structure as a product of the determined correction coefficient and the first distance for the specific structure (S100), and executes the travel control for the specific structure based on the determined fusion distance to the specific structure (S110).

According to the above configuration, the correction coefficient is determined from the above relationship based on the first distance for the specific structure. Further, the fusion distance to the specific structure is determined as the product of the correction coefficient and the first distance for the specific structure, and the travel control is executed for the specific structure based on the fusion distance.

Accordingly, the fusion distance to the specific structure can be determined based on the first distance, and the travel control can be executed for the specific structure based on the fusion distance, without requiring the second distance and the fusion process for the specific structure. Thus, the travel control can be executed by accurately detecting the distance to the specific structure without requiring an expensive sensor such as a LiDAR.

The “fusion distance” is a distance calculated based on the first distance and the second distance as the distance to a target detected by both the camera sensor and the radar sensor and identified by performing a fusion process on the detection results of the camera sensor and the radar sensor. The fusion distance may be the same as the second distance, and the accuracy of the fusion distance is equal to or higher than the accuracy of the first distance and the accuracy of the second distance.

In one aspect of the present disclosure, the specific structure (126) may be a curbstone of a road or a step between a roadway and a sidewalk.

According to the above aspect, in a situation in which a curbstone of a road or a step between a roadway and a sidewalk is present in the predetermined area, the travel control can be executed for the curbstone or the step based on the fusion distance to the curbstone or the step.

In another aspect of the present disclosure, the relationship may be a relationship among the first distance, a road surface gradient, and the correction coefficient (Kij) determined in advance for a plurality of first distances (Lci) and a plurality of road surface gradients (φj) for the traveling direction of the host vehicle.

The coefficient for a first distance for determining a fusion distance based on the first distance is different according to the road surface gradient for the traveling direction of the host vehicle. According to the above aspect, the above relationship is the relationship among the first distance, the road surface gradient, and the correction coefficient determined in advance for a plurality of first distances and a plurality of road surface gradients for the traveling direction of the host vehicle. Accordingly, the correction coefficient for determining the fusion distance according to the road surface gradient for the traveling direction of the host vehicle can be determined from the above relationship.

In still another aspect of the present disclosure, when it is determined that a distance-measurable target is present in the predetermined area, a distance to the distance-measurable target being measurable by the camera sensor and the radar sensor, and it is determined that the specific structure is present in the predetermined area between the host vehicle and the distance-measurable target (S40, S60), the control unit (driving assistance ECU 10) may determine the road surface gradient (φj) from the relationship based on the first distance (Lci) for the distance-measurable target and a ratio (Lfi/Lci) of the fusion distance to the first distance for the distance-measurable target (S80), determine the correction coefficient (Kij) from the relationship based on the determined road surface gradient and the first distance for the specific structure (S90), determine the fusion distance (Lfi) to the specific structure as the product of the determined correction coefficient and the first distance for the specific structure (S100), and execute the travel control for the specific structure based on the fusion distance to the specific structure (S110).

In some cases, a specific structure is present in the predetermined area between the host vehicle and a distance-measurable target, the distance to which can be measured by the camera sensor and the radar sensor. At that time, according to the above aspect, the road surface gradient is determined from the above relationship based on the first distance and the ratio of the fusion distance for the distance-measurable target. Further, a correction coefficient is determined from the above relationship based on the road surface gradient and the first distance for the specific structure, and a fusion distance to the specific structure is determined as the product of the correction coefficient and the first distance for the specific structure. Accordingly, the correction coefficient for determining the fusion distance to the specific structure can be determined as a value corresponding to the road surface gradient, whereby it is possible to execute the travel control by accurately detecting the distance to the specific structure without being affected by the road surface gradient.

In still another aspect of the present disclosure, the distance-measurable target may be an obstacle including at least one of a pedestrian, a bicycle, and a wheelchair that are present on a sidewalk.

There is a situation in which an obstacle including at least one of a pedestrian, a bicycle, and a wheelchair is present on a sidewalk and a specific structure is present between the host vehicle and the obstacle. In this situation, according to the above aspect, it is possible to effectively reduce the possibility that the host vehicle collides with the obstacle by executing the travel control for the specific structure.

In the above description, in order to help understand the present disclosure, the names and/or the reference signs used in the embodiment are added in parentheses to the components of the disclosure corresponding to the embodiment to be described later. However, the constituent elements of the present disclosure are not limited to the constituent elements of the embodiment corresponding to the names and/or the reference signs added in the parentheses. Other objects, other features, and accompanying advantages of the present disclosure will be readily understood from the description of the embodiment of the present disclosure made with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a travel control device according to an embodiment of the present disclosure;

FIG. 2 is a flowchart illustrating a travel control routine at the time of oblique travel according to the first embodiment;

FIG. 3 is a flowchart illustrating a travel control routine at the time of oblique travel according to the second embodiment;

FIG. 4 is a diagram illustrating a method of detecting a distance to a target object by a monocular camera device of a camera sensor;

FIG. 5 is a diagram illustrating an exemplary travel control during skew when an obstacle is present in a predetermined region but a specific structure is not present in a predetermined region; and

FIG. 6 is a diagram illustrating an example of travel control at the time of oblique travel in a case where an obstacle and a specific structure exist in a predetermined region.

### DETAILED DESCRIPTION OF EMBODIMENTS

Hereinafter, a vehicle travel control device according to an embodiment of the present disclosure will be described in detail with reference to the accompanying drawings.

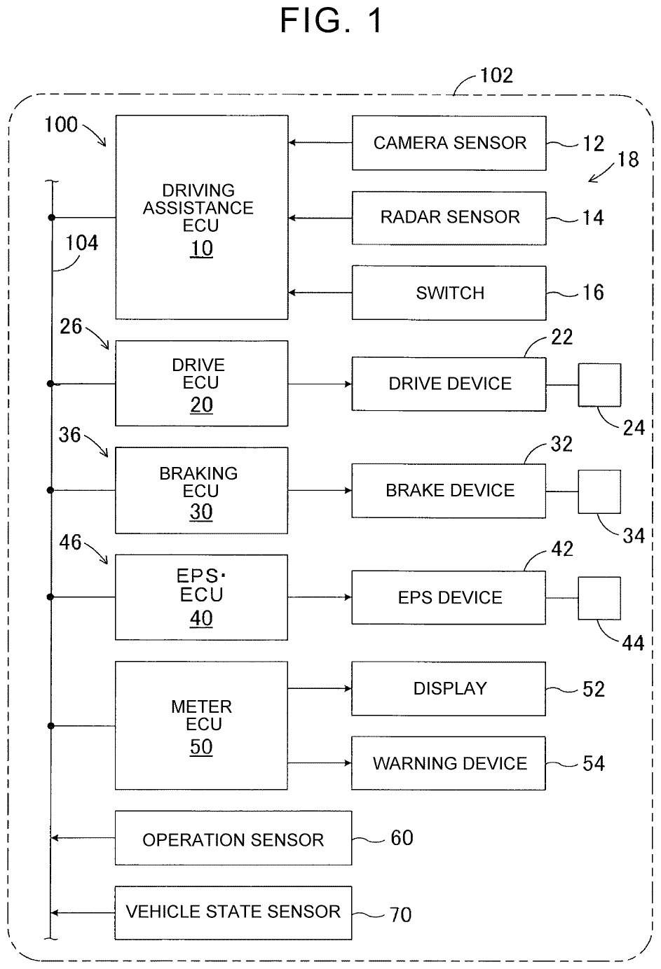

As shown in FIG. 1, a travel control device 100 according to an embodiment of the present disclosure is applied to vehicle 102 and includes a driving assistance ECU 10. The vehicle 102 is a vehicle capable of automated driving, and includes a driving ECU 20, a braking ECU 30, an electric power steering ECU 40, and a meter ECU 50. The ECU means an electronic control unit provided with a microcomputer as its main unit. In the following explanation, the electric power steering is referred to as an EPS.

A microcomputer of each ECU includes a central processing unit (CPU), a read-only memory (ROM), a random access memory (RAM), a readable and writable non-volatile memory (N/M), an interface (I/F), and the like. The CPU realizes various functions by executing instructions (programs, routines) stored in the ROM. Further, these ECUs are connected to each other such that data is exchangeable (communicable) via a controller area network (CAN) 104. Therefore, detected values of sensors (including switches) connected to a specific ECU are transmitted to other ECUs as well.

The driving assistance ECU 10 is a central control device that controls driving assistance such as collision-avoidance control and travel control at the time of skew. In the embodiment, the driving assistance ECU 10 cooperates with other ECU to execute the driving control in the case of skew, as will be described later.

A camera sensor 12, a radar sensor 14, and a switch 16 are connected to the driving assistance ECU 10. The camera sensor 12 and radar sensor 14 each include a plurality of camera devices and a plurality of radar devices. The camera sensor 12 and the radar sensor 14 function as a target information acquisition device 18 that acquires target information around the vehicle 102.

Each camera device of the camera sensor 12 includes a camera unit that captures an image of the surroundings of the vehicle 102, and a recognition unit that analyzes image data obtained by capturing an image by the camera unit and recognizes a target such as a white line of a road or another vehicle, although not shown in the drawing. The recognition unit supplies information about the recognized target to the driving assistance ECU 10 at predetermined intervals. In particular, the camera sensor 12 can measure the distance to the target object as the first distance Lc, and supplies the information of the first distance to the driving assistance ECU 10 at predetermined intervals.

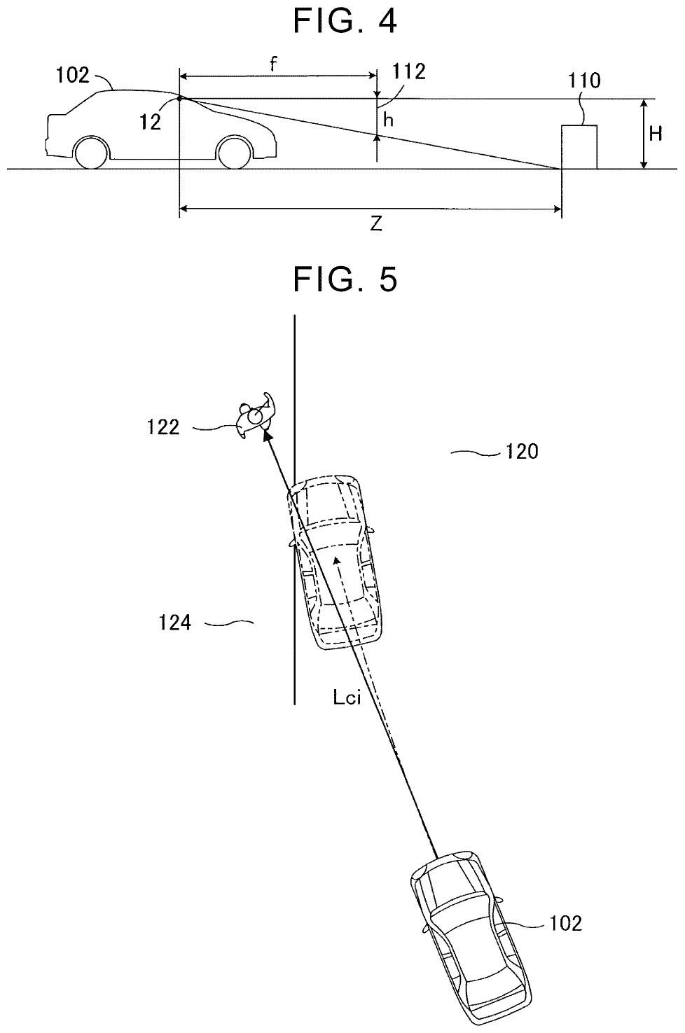

The camera device of the camera sensor 12 may be either a compound-eye camera device or a single-eye camera device, but in the embodiment, the camera device is a single-eye camera device. If the camera device is a monocular camera device, the distance from the camera device to the target is estimated by a method based on a pinhole camera model, as shown in FIG. 4.

In FIG. 4, it is assumed that the target object 110 is located in front of the host vehicle 102, the distance between the center of the lens (not shown) of the camera device of the camera sensor 12 and the target object is Z, and the height of the center of the lens is H. In FIG. 4, for convenience of explanation, the imaging surface 112 is illustrated outside the camera apparatus, but the distance corresponding to the height H of the imaging surface 112 in the camera apparatus is h, and the focal length of the lens is f.

The distance h is detectable and the focal length f is a known value. A right-angled triangle having sides of lengths f and h of 90° is similar to a right-angled triangle having sides of lengths Z and H of 90°. Therefore, the distance Z can be calculated by f×H/h.

Each radar device of the radar sensor 14 detects a distance between the host vehicle and the three-dimensional object, a relative speed between the host vehicle and the three-dimensional object, a relative position (direction) of the three-dimensional object with respect to the host vehicle, and the like by using radio waves in the millimeter wave band. The radar devices of the radar sensor 14 supply information representing the radar devices to the driving assistance ECU 10 at predetermined intervals. In particular, the radar sensor 14 can measure the distance to the target object as the second distance Ll, and supplies the second distance information to the driving assistance ECU 10 at predetermined intervals. The accuracy of the second distance Li is higher than the accuracy of the first distance Lc.

The driving assistance ECU 10 performs a fusion process on the detection results of the camera sensor 12 and the radar sensor 14. By this process, the target detected by both sensors is identified, and the fusion distance Lf to the identified target is calculated based on the first distance Lc and the second distance Ll. Note that the fusion distance Lf may be the same as the second distance Ll, and the accuracy of the fusion distance Lf is equal to or more than the accuracy of the first distance Le and the accuracy of the second distance Ll.

The switch 16 is provided at a position operable by a driver, such as a steering wheel, which is not shown in FIG. 1, and is operable by the driver. The switch 16 includes a collision avoidance switch. When the collision avoidance switch is on, the driving assistance ECU 10 executes collision avoidance control and travel control at the time of skew.

The driving assistance ECU 10 determines whether or not an obstacle exists in a predetermined area in the traveling direction of the host vehicle 102 based on the detection results of the camera sensor 12 and the radar sensor 14. When it is determined that an obstacle exists, the driving assistance ECU 10 executes collision avoidance control for avoiding collision between the host vehicle and the obstacle. The obstacle is an obstacle to the traveling of the host vehicle, and includes not only one in which the host vehicle is damaged when colliding like another vehicle or a stationary object, but also one in which the host vehicle is damaged when colliding like a pedestrian.

In addition, the driving assistance ECU 10 determines whether or not the host vehicle 102 is skewed, that is, whether or not the host vehicle is traveling inclined with respect to the road, based on the detection results of the camera sensor 12 and the radar sensor 14, as will be described later. When it is determined that the host vehicle is skewed, the driving assistance ECU 10 executes travel control at the time of skewing.

A drive device 22 that accelerates the vehicle 102 by applying a driving force to the driving wheels 24 is connected to the driving ECU 20. The driving ECU 20 normally controls the drive device 22 such that a driving force generated by the drive device 22 changes in accordance with a driving operation by the driver, and controls the drive device 22 based on a command signal when the driving ECU 20 receives the command signal from the driving assistance ECU 10. Thus, the driving ECU 20 and the drive device 22 cooperate with each other to function as the drive control device 26.

A braking device 32 is connected to the braking ECU 30 to decelerate the vehicle 102 by braking by applying a braking force to the wheels 34. The braking ECU 30 controls the braking device so that the braking force generated by the braking device 32 changes in response to a braking operation by the driver in a normal state. Upon receiving the command signal from the driving assistance ECU 10, the braking ECU 30 performs the automated braking by controlling the braking device 32 based on the command signal.

Thus, the braking ECU 30 and the braking device 32 cooperate with each other to function as the braking control device 36, and the braking force of the entire vehicle 102 can be controlled, and the braking force of the respective wheels can be individually controlled. When braking force is applied to the wheels by parking control or the like, a brake lamp (not shown in FIG. 1) is turned on.

An EPS device 42 is connected to the EPS-ECU 40. EPS ECU 40 controls EPS device 42 in a manner known in the art based on the steering torque Ts and the vehicle speed V detected by the driving operation sensor 60 and the vehicle state sensor 70 described later. Accordingly, EPS ECU 40 controls the steering assist torque to reduce the steering burden on the driver. Further, EPS ECU 40 can steer the steered wheels 44 as needed by controlling EPS device 42. Thus, EPS ECU 40 and EPS device 42 functions as a steering control device 46 that automatically steers the steered wheels as needed.

The meter ECU 50 is connected with a touch panel-type display 52 for displaying a state of control by the driving assistance ECU 10 and an alarm device 54 for issuing an alarm. The display 52 may be, for example, a multi-information display in which meters and various types of information are displayed, or may be a display of a navigation device. The display 52 may be configured to display the status of the collision avoidance control and the travel control at the time of skew when receiving a signal from the driving assistance ECU 10.

The alarm device 54 is activated when it is determined that the vehicle 102 is likely to collide with an obstacle, and issues an alarm indicating that there is a risk of collision. The alarm device 54 may be any of an alarm device that issues a visual alarm such as an alarm lamp, an alarm device that emits an auditory alarm such as an alarm buzzer, and an alarm device that issues a bodily alarm such as vibration of a seat, and may be any combination thereof.

The driving operation sensor 60 and the vehicle-state sensor 70 are also connected to CAN 104. Information detected by the driving operation sensor 60 and the vehicle state sensor 70 (hereinafter referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a drive operation amount sensor that detects an operation amount of an accelerator pedal, a braking operation amount sensor that detects a master cylinder pressure or a depression force applied to a brake pedal, and a brake switch that detects whether the brake pedal is operated. The driving operation sensor 60 includes a steering angle sensor for detecting a steering angle, a steering torque sensor for detecting a steering torque, and the like.

The vehicle state sensor 70 includes a vehicle speed sensor for detecting a vehicle speed of the vehicle 102, a longitudinal acceleration sensor for detecting an acceleration in the longitudinal direction of the vehicle, a lateral acceleration sensor for detecting an acceleration in the lateral direction of the vehicle, a yaw rate sensor for detecting a yaw rate of the vehicle, and the like.

### First Embodiment

ROM of the driving assistance ECU 10 stores a map of the relation between the plurality of first distance Lei (i=1, 2 . . . n, n is a positive integer) and the correction coefficient Ki for determining the fusion distance Lfi based on the first distance Lei, as shown in Table 1 below. The correction coefficient Ki is a value obtained in advance for a plurality of first distance Lei in a situation where the host vehicle 102 travels on a horizontally flat road. The correction coefficient Ki may be, for example, a product of the first distance Lei and the correction coefficient Ki, and the fusion distance Lfi may be a specific Lfi/Lci of the fusion distance Lfi with respect to the first distance Lei.

TABLE 1

First distance Lci

| | Lc1 | Lc2 | Lc3 | . . . | Lcn |
|---|---|---|---|---|---|
| correction | K1 | K2 | K3 | . . . | Kn |
| coefficient Ki | | | | | |

The driving assistance ECU 10 sometimes determines that an obstacle and a specific structure exist in a predetermined area and the specific structure is located between the obstacle and the host vehicle in a situation where the host vehicle 102 is skewed with respect to the road. The correction coefficient Ki is then determined from the map of relationships shown in Table-1 based on the first distance Lci for the particular construction. Further, the driving assistance ECU 10 determines the fusion distance Lfi to the specific structure as a product of the determined correction coefficient Ki and the first distance Lci for the specific structure. The driving assistance ECU 10 executes travel control at the time of skew travel for a particular structural object based on the obtained fusion distance Lfi.

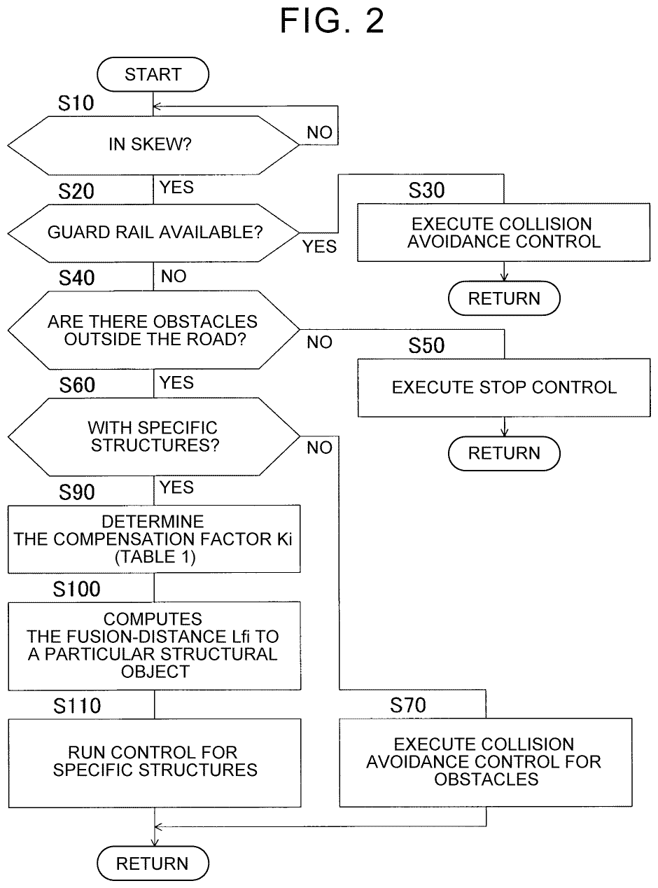

In the first embodiment, ROM of the driving assistance ECU 10 stores a program for controlling the traveling object at the time of skewing corresponding to the flow chart shown in FIG. 2.

### Travel Control During Skew (FIG. 2)

Next, with reference to the flowchart shown in FIG. 2, a description will be given of the travel control at the time of skew travel in the first embodiment. The travel control at the time of skew according to the flow chart shown in FIG. 2 is repeatedly executed at predetermined intervals by CPU of the driving assistance ECU 10 in a situation where the collision-avoidance switch of the switch 16 is on. In the following description, the travel control at the time of skew travel is referred to as “main control”.

First, in S10, CPU determines whether or not the host vehicle 102 is skewed with respect to the road, that is, whether or not the host vehicle is traveling inclined with respect to the lane, based on the information of the target acquired by the target information acquisition device 18. When a negative determination is made, the present control ends once, and when an affirmative determination is made, the present control proceeds to S20.

When a negative determination is made, the travel control during normal traveling may be performed in any manner known in the art. For example, based on the information of the target acquired by the target information acquisition device 18, it is determined whether or not there is an obstacle in a predetermined area in front of the host vehicle 102, and when it is determined that there is an obstacle, the collision allowance time TTC is calculated. Further, the target deceleration of the host vehicle is calculated based on the collision allowance time TTC, and the drive control device 26 and the braking control device 36 are controlled so that the deceleration of the host vehicle becomes the target deceleration. Further, the steering control device 46 may be controlled as needed.

In S20, CPU determines whether or not there is a guardrail in front of the host vehicle 102 based on the information of the target acquired by the target information acquisition device 18. When a negative determination is made, the present control proceeds to S40, and when an affirmative determination is made, the present control proceeds to S30.

In S30, CPU executes collision-avoidance control at the time of skewing on the guard rail. Collision avoidance control at the time of skew of the guard rail may be performed in any manner known in the art, for example, as described in Japanese Unexamined Patent Application Publication No. 2017-226393 (JP 2017-226393 A).

In S40, CPU determines whether or not there is an obstacle including at least one of a pedestrian, a bicycle, and a wheelchair in a predetermined area outside the roadway in front of the host vehicle 102, for example, on the sidewalk, based on the information of the target acquired by the target information acquisition device 18. When an affirmative determination is made, the present control proceeds to S60, and when a negative determination is made, the present control proceeds to S50.

In S50, CPU controls the drive control device 26 and the braking control device 36 to decelerate and stop the host vehicle so that the host vehicle 102 does not deviate from the roadway as much as possible. Note that the steering control device 46 may be controlled as necessary.

In S60, CPU determines whether or not there is a particular object between the host vehicle and the obstacle in a predetermined area in front of the host vehicle 102 based on the information of the object acquired by the target information acquisition device 18. When an affirmative determination is made, the present control proceeds to S90, and when a negative determination is made, the present control proceeds to S70.

In S70, CPU performs collision-avoidance control on the obstacle. For example, the collision allowance time TTC is calculated for the obstacle, the target deceleration of the host vehicle is calculated based on the collision allowance time TTC, and the drive control device 26 and the braking control device 36 are controlled so that the deceleration of the host vehicle becomes the target deceleration. Note that the steering control device 46 may be controlled as necessary.

In S90, CPU determines a correction coefficient Ki from the map of relationships shown in Table-1 based on the first distance Lei for the particular construct detected by the camera sensor 12. When the first distance Lei is a value that is not in the map, the correction coefficient Ki may be obtained from the map based on a value closest to the first distance Lei among the values in the map. Alternatively, a correction coefficient Lei corresponding to the first distance Ki may be obtained by proportional allocation by determining two correction coefficients Ki from the map based on two values closest to the first distance Lei among the values in the map.

In S100, CPU computes the fusion distance Lfi to a particular construct as the product of the correction coefficient Ki and the first distance Lei.

In S110, CPU executes the travel control at the time of skew for a particular structural object based on the fusion distance Lfi. Travel control during skew for a specific structure may be performed in any manner known in the art. For example, it may be executed in the manner described in JP 2017-226393 A.

For example, FIG. 5 illustrates a situation in which the host vehicle 102 is skewed with respect to the roadway 120, a pedestrian 122 as an obstacle exists in a predetermined area in front of the host vehicle, and a specific structure does not exist between the host vehicle and the pedestrian. The pedestrian 122 is located on a sidewalk 124 outside the roadway 120, and there is no specific structure, such as a curb or step, or guardrail between the roadway and the sidewalk.

In this situation, an affirmative determination is made in S10, a negative determination is made in S20, an affirmative determination is made in S40, and a negative determination is made in S60. Therefore, since the collision avoidance control is executed for the pedestrian 122 in S70, the host vehicle 102 is decelerated and stopped so as not to collide with the pedestrian 122.

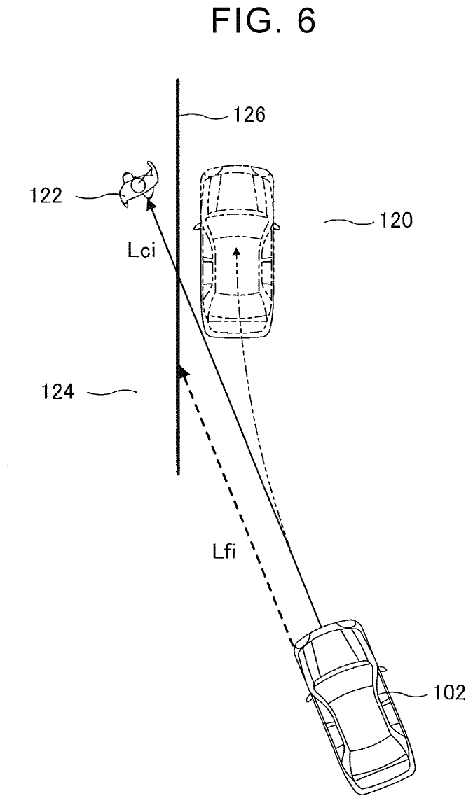

FIG. 6 shows a situation in which the host vehicle 102 is skewed with respect to the roadway 120, a pedestrian 122 as an obstacle exists in a predetermined region in front of the host vehicle, and a curbstone 126 as a specific structure exists between the host vehicle and the pedestrian. There is no guardrail between the roadway and the sidewalk.

In this circumstance, an affirmative determination is made in S10, a negative determination is made in S20, and an affirmative determination is made in S40 and S60. Therefore, in S90, the correction coefficient Ki is obtained from the map of the relation shown in Table 1 based on the first distance Lc about the curbstone 126 detected by the camera sensor 12. Further, in S100, the fusion distance Lfi to the curbstone 126 is calculated as the product of the correction coefficient Ki and the first distance Lc, and in S110, travel control at the time of skewing is executed for the curbstone 126.

Since the fusion distance Lfi is more accurate than the first distance Lc, the travel control can be effectively executed as compared to when the travel control is executed based on the first distance Lc. Therefore, it is possible to automatically decelerate the host vehicle so that the host vehicle 102 can change direction without colliding with or riding on the curbstone 126 by the steering of the driver, and thus it is possible to effectively reduce the possibility that the host vehicle collides with the pedestrian 122.

### Second Embodiment

In the second embodiment, ROM of the driving assistance ECU 10 stores a map of the relation between the plurality of first distances Lci (i=1, 2 . . . n, n is a positive integer) and the gradients φj (j=1, 2 . . . m, m is a positive integer) of the plurality of road surfaces and the correction coefficient Kij, as shown in 2 below. The correction coefficient Kij is a value obtained in advance for the plurality of first distances Lci and the gradients φj of the plurality of road surfaces as a correction coefficient for obtaining the corresponding fusion distance Lfi based on the first distance Lci. The slope φj of the road surface is the slope of the road surface with respect to the traveling direction of the host vehicle. Also in the second embodiment, the correction coefficient Kij may be a correction coefficient for the first distance Lfi for determining the fusion distance Lci, for example, a specific Lfi/Lci of the fusion distance Lfi for the first distance Lci. The slope φj of the road surface is larger as j is smaller, the slope of the descent is larger as j is larger, and the slope of the ascent is larger, and the slope between them is 0.

TABLE 2

| correction | |
|---|---|
| coefficient | First distance Lci |

| | | | | | |
|---|---|---|---|---|---|
| Kij | Lc1 | Lc2 | Lc3 | . . . | Lcn |

| | | | | | | |
|---|---|---|---|---|---|---|
| Slope | φ1 | K11 | K21 | K31 | . . . | Kn1 |
| φj of | φ2 | K12 | K22 | K32 | . . . | Kn2 |
| the | φ3 | K13 | K23 | K33 | . . . | Kn3 |
| road | . | . | . | . | . . . | . |
| surface | . | . | . | . | | . |
| | . | . | . | . | | . |
| | φm | K1m | K2m | K3m | . . . | Knm |

When the driving assistance ECU 10 determines that the obstacle and the specific structure exist in a predetermined area and the specific structure is located between the obstacle and the host vehicle in a situation where the host vehicle 102 is skewed with respect to the road, the driving assistance ECU 10 determines the fusion distance Lfi to the obstacle. The fusion distance Lfi to the obstacle is determined in a manner known in the art based on the first distance Lei to the obstacle and the second distance Lli. The driving assistance ECU 10 calculates a ratio Lfi/Lci of the fusion distance Lfi with respect to the first distance Lei, and determines a correction coefficient Kij closest to the ratio Lfi/Lci among the correction coefficients Ki in the map of the relation shown in Table 2. The driving assistance ECU 10 determines the slope φj of the road surface corresponding to the determined correction coefficient Kij.

The driving assistance ECU 10 obtains a correction coefficient Kij from the map of relations shown in Table 2 based on the first distance Lei for the particular construction and the determined slope φj of the road surface. Further, the driving assistance ECU 10 determines the fusion distance Lfi to the specific structure as a product of the determined correction coefficient Kij and the first distance Lei for the specific structure. The driving assistance ECU 10 executes travel control at the time of skew travel for a particular structural object based on the obtained fusion distance Lfi.

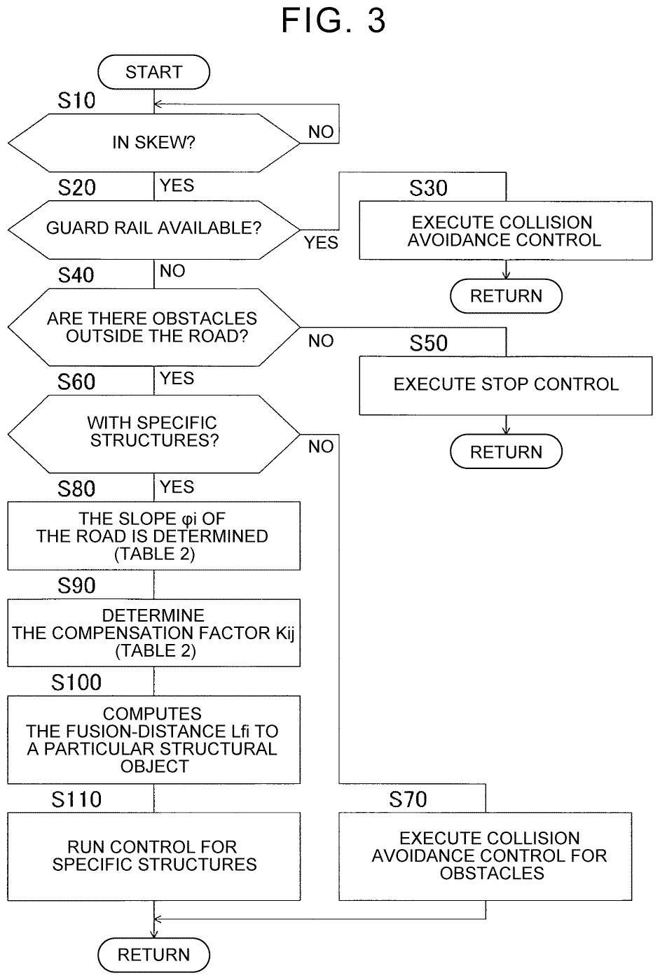

In the second embodiment, ROM of the driving assistance ECU 10 stores a driving control program at the time of skew corresponding to the flow chart shown in FIG. 3. Travel control during skew (FIG. 3)

The travel control at the time of skew according to the flow chart shown in FIG. 3 is also repeatedly executed at predetermined intervals by CPU of the driving assistance ECU 10 in a situation where the collision-avoidance switch of the switch 16 is on.

As can be seen from comparing FIG. 3 with FIG. 2, steps other than S80 to S100 are performed in the same manner as in the first embodiment, and S80 is performed when an affirmative determination is made in S60.

In S80, CPU obtains the fusion distance Lfi to the obstacle based on the first distance Lci and the second distance Lli detected by the camera sensor 12 and the radar sensor 14, respectively. CPU calculates a ratio Lfi/Lci of the fusion distance Lfi with respect to the first distance Lci, and determines a correction coefficient Kij closest to the ratio Lfi/Lci among the correction coefficients Kij in the map of the relation shown in Table 2. CPU determines a slope φj of the road surface corresponding to the determined correction coefficient Kij.

In S90, CPU obtains a correction coefficient Kij from the map of relationships shown in Table 2 based on the first distance Lci and the slope φj of the road surface for the particular construction.

Further, in S100, CPU determines the fusion distance Lfi to the specific structure as the product of the correction coefficient Kij and the first distance Lci for the specific structure. Thereafter, in S110, the travel control at the time of skew is executed for a particular structural object based on the fusion distance Lfi.

As can be seen from the above explanation, according to the first and second embodiments, the correction coefficients Ki or Kij are obtained from the relations of Table 1 or Table 2, respectively, based on the first distance for a particular construction. Further, a fusion distance Lfi to a specific structure is determined as a product of a correction coefficient and a first distance Lci for the specific structure, and travel control is performed for the specific structure based on the fusion distance.

Therefore, the fusion distance to the specific structure can be obtained based on the first distance without requiring the second distance and the fusion process for the specific structure, and the travel control can be executed for the specific structure based on the fusion distance. Therefore, the travel control can be executed by accurately detecting the distance to a particular structural object without requiring an expensive sensor such as a LiDAR.

In particular, according to the second embodiment, the relationship in Table 2 is the relationship between the first distance determined in advance for the plurality of first distances Lci and the inclination φj of the plurality of road surfaces with respect to the traveling direction of the host vehicle, the inclination of the road surface, and the correction coefficient Kij. Therefore, the correction coefficient Kij for determining the fusion distance in accordance with the slope of the road surface with respect to the traveling direction of the host vehicle 102 can be obtained from the relation shown in Table 2.

Further, according to the second embodiment, the slope φj of the road surface is obtained from the relationship of Table 2 based on the ratio of the fusion distance to the first distance for the object capable of distance measurement. Further, the correction coefficient Kij is determined from the relation of Table 2 based on the slope of the road surface and the first distance Lci for the specific structure, and the fusion distance Lfi to the specific structure is determined as the product of the correction coefficient and the first distance for the specific structure. Therefore, the correction coefficient for obtaining the fusion distance can be obtained as a value corresponding to the slope of the road surface with respect to the traveling direction of the host vehicle. As a result, it is possible to accurately detect the distance to a specific structure without being affected by the slope of the road surface, and to execute the travel control.

The present disclosure has been described in detail above with respect to specific embodiments. However, it is obvious to those skilled in the art that the present disclosure is not limited to the above-described embodiments, and various other embodiments are possible within the scope of the present disclosure.

For example, in the above-described first and second embodiments, the travel control executed for a specific structure based on the fusion distance to the specific structure is executed at the time of skew of the host vehicle. However, the travel control may be executed at a time of travel other than the time of skew travel of the host vehicle.

In the first and second embodiments described above, the distance-measurable target object is an obstacle including at least one of a pedestrian, a bicycle, and a wheelchair present on a sidewalk. However, the distance-measurable target may be an obstacle other than a pedestrian, a bicycle, or a wheelchair present on a sidewalk.

Further, in the first and second embodiments described above, when it is determined in S60 that there is no particular structural object between the host vehicle and the obstacle, S70 is executed. However, when a white line, which is a boundary of a lane, is detected, the same control as the travel control for a specific structure may be performed based on the white line.

What is claimed is:

1. A vehicle travel control device comprising: a camera sensor and a radar sensor that measure a distance to a target as a first distance and a second distance, respectively; and a control unit that executes travel control for reducing a possibility of a collision between a host vehicle and an obstacle when it is determined that the obstacle is present in a predetermined area in a traveling direction of the host vehicle based on detection results of the camera sensor and the radar sensor, wherein:
the control unit stores a relationship between the first distance and a correction coefficient determined in advance for a plurality of first distances, the correction coefficient being a coefficient for the first distance for determining, based on the first distance, a fusion distance based on the first distance and the second distance; and
when it is determined that a specific structure is present in the predetermined area, a distance to the specific structure being measurable by the camera sensor but it being difficult for the radar sensor to measure an accurate distance to the specific structure, the control unit determines a correction coefficient from the relationship based on the first distance for the specific structure, determines a fusion distance to the specific structure as a product of the determined correction coefficient and the first distance for the specific structure, and executes the travel control for the specific structure based on the determined fusion distance to the specific structure.

2. The vehicle travel control device according to claim 1, wherein the specific structure is a curbstone of a road or a step between a roadway and a sidewalk.

3. The vehicle travel control device according to claim 1, wherein the relationship is a relationship among the first distance, a road surface gradient, and the correction coefficient determined in advance for a plurality of first distances and a plurality of road surface gradients for the traveling direction of the host vehicle.

4. The vehicle travel control device according to claim 3, wherein when it is determined that a distance-measurable target is present in the predetermined area, a distance to the distance-measurable target being measurable by the camera sensor and the radar sensor, and it is determined that the specific structure is present in the predetermined area between the host vehicle and the distance-measurable target, the control unit determines the road surface gradient from the relationship based on the first distance for the distance-measurable target and a ratio of the fusion distance to the first distance for the distance-measurable target, determines the correction coefficient from the relationship based on the determined road surface gradient and the first distance for the specific structure, determines the fusion distance to the specific structure as the product of the determined correction coefficient and the first distance for the specific structure, and executes the travel control for the specific structure based on the fusion distance to the specific structure.

5. The vehicle travel control device according to claim 4, wherein the distance-measurable target is an obstacle including at least one of a pedestrian, a bicycle, and a wheelchair that are present on a sidewalk.
